(19) United States
(12) Patent Application Publication
(10) Pub. No.: US 2013/0294401 A1
(43) Pub. Date: Nov. 7, 2013

(54) METHOD AND DEVICE FOR MUTING POSITIONING REFERENCE SIGNAL IN HETEROGENEOUS COMMUNICATION ENVIRONMENT AND METHOD AND DEVICE FOR MEASURING POSITION USING SAME

(71) Applicant: Sungjun Yoon, Seoul (KR)

(72) Inventor: Sungjun Yoon, Seoul (KR)

(21) Appl. No.: 13/979,255

(22) PCT Filed: Jan. 12, 2012
(86) PCT No.: PCT/KR2012/000311

§ 371 Date: Jul. 11, 2013

(30) Foreign Application Priority Data
Jan. 14, 2011 (KR) 10-2011-0004165

(51) Int. Cl. H04W 72/08

(52) U.S. Cl. CPC H04W 72/082
USPC 370/330; 370/329

(57) ABSTRACT

The present invention relates to a method and a device for muting a positioning reference signal (PRS) in a wireless communication system, in particular, a heterogeneous communication system, and to a method for measuring the position of a user equipment using same. In the heterogeneous communication system having one or more macro cells and one or more non-macro cells located inside each of the macro cells, the non-macro cells do not transmit the PRS separately, and do not transmit data but execute muting in a time-frequency resource area where one or more specific macro cells from the macro cells transmit the PRS. The present invention can be used to minimize the influence of interference between base stations of different forms in the heterogeneous communication environment, and promote enhancement of accuracy in measuring the position of the user equipment.

### CROSS-REFERENCE TO RELATED APPLICATIONS

This application is the National Stage Entry of International Application PCT/KR2012/000311, filed on Jan. 12, 2012, and claims priority from and the benefit of Korean Patent Application No. 10-2011-0004165, filed on Jan. 14, 2011, both of which are incorporated herein by reference in their entireties for all purposes as if fully set forth herein.

### BACKGROUND

1. Field

The present invention relates to a method and a device for muting a positioning reference signal (PRS) in a wireless communication system, particularly, in a heterogeneous communication system, and a positioning method for a user equipment using the same.

2. Discussion of the Background

As communication systems have developed, various wireless terminals have been utilized by consumers such as companies and individuals.

Current mobile communication systems, for example, 3GPP, LTE (Long Term Evolution), LTE-A (LTE-Advanced), and the like, may be high capacity communication systems capable of transmitting and receiving various types of data such as image data, wireless data, and the like, beyond providing a sound-based service. Accordingly, there is a desire for a technology that transmits high capacity data, which is comparable to a wired communication network. Also, the system is required to include an appropriate error detection scheme that minimizes a loss of information and increases transmission efficiency of the system so as to enhance performance of the system.

Also, varied reference signals have been proposed in current various communication systems to provide information associated with a communication environment and the like to a counterpart device through an uplink or a downlink.

To measure a position of a user equipment (User Equipment; hereinafter referred to as a user equipment or a UE), each cell or a base station transmits a positioning reference signal (PRS) to a UE, and the corresponding UE receives a positioning reference signal transmitted from each base station in a predetermined time and measures a position.

Current communication systems such as an LTE take merely a macro cell into consideration, and the macro cell adopts an architecture of transmitting a positioning reference signal (PRS) over successive N subframes based on a predetermined period (T subframes).

However, in a heterogeneous communication environment where a non-macro cell, such as a pico cell or a femto cell, exists in each macro cell, a user equipment in a predetermined non-macro cell receives a signal from a macro cell in addition to a signal from the non-macro cell. Therefore, a positioning reference signal defined based on a conventional technology that merely takes the macro cell into consideration has a disadvantage in that a reception error probability of a positioning reference signal increases due to interference from different types of non-macro cells, such as a pico cell and the like.

### SUMMARY

Therefore, the present invention has been made in view of the above-mentioned problems, and an aspect of the present invention is to provide a positioning reference signal muting method and device for muting a positioning reference signal in a wireless communication system.

Another aspect of the present invention is to provide a positioning reference signal muting method and device that precisely measures a position of a user equipment in a heterogeneous communication system including a macro cell and a non-macro cell.

Another aspect of the present invention is to provide a method and a device for muting a predetermined resource area based on muting information obtained from a macro cell to which a non-macro cell transmits a positioning reference signal such as a pico cell, in a heterogeneous communication system including a macro cell and a non-macro cell.

In accordance with an aspect of the present invention, there is provided a method of muting a positioning reference signal (PRS) in a communication system including one or more macro cells and one or more non-macro cells included in the macro cells, the method for the non-macro cell including: determining, based on muting information, a PRS transmission resource area of one or more predetermined macro cells from among the macro cells; generating a PRS muting resource area by muting a resource area corresponding to the PRS transmission resource area of the one or more predetermined macro cells during resource allocation; generating an OFDM signal by taking into consideration the PRS muting resource area; and transmitting the generated OFDM signal.

In accordance with another aspect of the present invention, there is provided a device for muting a positioning reference signal (PRS) of a non-macro cell in a communication system including one or more macro cells and one or more non-macro cells included in the macro cells, the device including: a muting information receiving unit to receive muting information from one or more predetermined macro cells from among the macro cells or from a higher layer; a PRS muting resource area determining unit to determine, based on the muting information, a time-frequency resource area where a predetermined macro cell transmits a PRS as a muting target resource element (RE; Resource Element); and a muting unit to allocate a resource so as not to allocate data or to perform zero-power transmission with respect to the muting target RE.

In accordance with another aspect of the present invention, there is provided a positioning method for a positioning device that receives a positioning reference signal (PRS) and measures a position in a communication system including one or more macro cells and one or more non-macro cells included in the macro cells, the method for the positioning device including: receiving an OFDM signal generated through allocation of a PRS sequence, from one or more predetermined macro cells from among the macro cells, and receiving, from the non-macro cell, an OFDM signal generated through muting of a resource area to which a PRS sequence of the predetermined macro cell is allocated; demodulating the OFDM signal transmitted from the predetermined macro cell; extracting a PRS sequence of the predetermined macro cell from the demodulated OFDM signal; and estimating positional information using the extracted PRS sequence.

In accordance with another aspect of the present invention, there is provided a positioning device for receiving a positioning reference signal (PRS) and measuring a position in a communication system including one or more macro cells and one or more non-macro cells included in the macro cells, the device including: a reception processor to receive an OFDM signal generated through allocation of a PRS sequence, from one or more predetermined cells from among the macro cells, and to receive, from the non-macro cell, an OFDM signal generated through muting of a resource area to which a PRS sequence of the predetermined macro cell is allocated; a PRS sequence extracting unit to perform demapping of information allocated to each resource element of the OFDM signal received from the predetermined macro cell, and to extract a PRS sequence of the predetermined macro cell that transmits the corresponding OFDM signal; and a positioning unit to estimate positional information using the one or more extracted PRS sequences.

In accordance with another aspect of the present invention, there is provided a positioning reference signal (PRS) muting method in a heterogeneous communication system including one or more macro cells and one or more non-macro cells included in each macro cell, wherein the non-macro cell does not separately transmit a positioning reference signal, and does not transmit data and instead performs muting in a time-frequency resource area where one or more predetermined macro cells from among the macro cells transmit a positioning reference signal.

### BRIEF DESCRIPTION OF THE DRAWINGS

FIG. 1 is a diagram schematically illustrating a wireless communication system according to an embodiment of the present invention;

FIG. 2 illustrates a general structure of a subframe and a time-slot of transmission data according to an embodiment of the present invention;

FIG. 3 illustrates a PRS pattern of a communication system that takes only a macro cell into consideration;

FIG. 4 illustrates a signal transmission scheme of a PRS;

FIG. 5 illustrates a PRS transmission status in a heterogeneous communication environment according to the present invention;

FIG. 6 is a flowchart illustrating a PRS muting method according to an embodiment of the present invention;

FIG. 7 is a flowchart illustrating a PRS muting method according to a first embodiment of the present invention;

FIG. 8 illustrates an example of a PRS muting resource area that is generated by a pico cell in the first embodiment of FIG. 7;

FIG. 9 is a flowchart illustrating a PRS muting method according to a second embodiment of the present invention;

FIG. 10 illustrates an example of a PRS muting resource area that is generated by a pico cell in the second embodiment of FIG. 9;

FIG. 11 is a block diagram illustrating a PRS muting device that performs PRS muting according to an embodiment of the present invention;

FIG. 12 is a functional block diagram illustrating a pico cell device or a non-macro cell device that performs PRS muting according to an embodiment of the present invention.

FIG. 13 is a flowchart illustrating a positioning method according to an embodiment of the present invention; and

FIG. 14 is a diagram illustrating a configuration of a positioning device or PRS receiving device according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

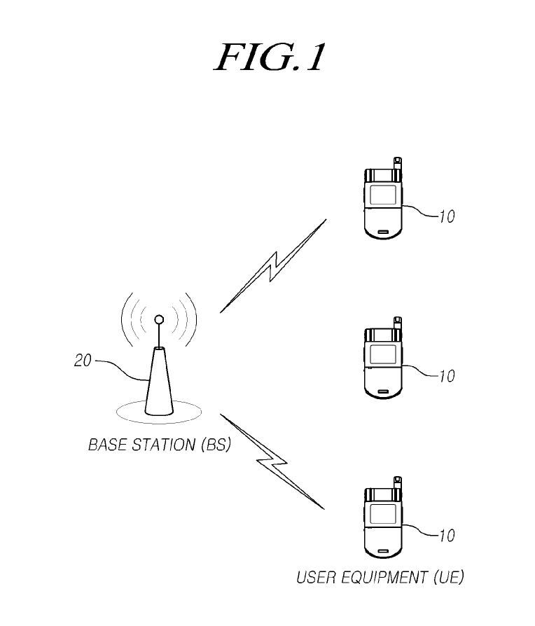

FIG. 1 illustrates a wireless communication system according to embodiments of the present invention.

The wireless communication system may be widely installed so as to provide various communication services, such as a voice service, packet data, and the like.

Referring to FIG. 1, the wireless communication system may include a user equipment (UE) 10 and a base station (BS) 20.

Throughout the specifications, the user equipment 10 may be an inclusive concept indicating a user terminal utilized in wireless communication, including a UE in WCDMA, LTE, HSPA, and the like, and an MS (Mobile Station), a UT (User Terminal), an SS (Subscriber Station), a wireless device, and the like in GSM.

In the specifications, the user equipment 10 and the base station 20 are used as two inclusive transceiving subjects to embody the technology and technical concepts described in the specifications, and may not be limited to a predetermined term or word.

The base station 20 or a cell may refer to a fixed station where communication with the user equipment 10 is performed, and may also be referred to as a Node-B, an eNodeB (evolved Node-B), a BTS (Base Transceiver System), an access point, a relay node, remote radio head (RRH), and the like.

That is, a base station or a cell may be construed as an inclusive concept including a partial area covered by a BSC (Base Station Controller), a NodeB of WCDMA, and the like, or a device or hardware/software for managing the same, and may be used as a concept equivalent to a mega cell, a macro cell, a micro cell, a pico cell, a femto cell, a relay node, an RRH, and the like.

In the specifications, the user equipment 10 and the base station 20 are used as two inclusive transceiving subjects to embody the technology and technical concepts described in the specifications, and may not be limited to a predetermined term or word. The wireless communication system may utilize varied multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like.

Uplink transmission and downlink transmission may be performed based on a TDD (Time Division Duplex) scheme that performs transmission based on different times, or based on an FDD (Frequency Division Duplex) scheme that performs transmission based on different frequencies.

An embodiment of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. Embodiments of the present invention may not be limited to a specific wireless communication field, and may be applicable to all technical fields to which a technical idea of the present invention is applicable.

The wireless communication system may support an uplink and/or downlink HARQ, and may use a CQI (channel quality indicator) for link adaptation. Also, a multiple access scheme for downlink transmission and a multiple access scheme for uplink transmission may be different from each other. For example, a downlink may use OFDMA (Orthogonal Frequency Division Multiple Access) and an uplink may use SC-FDMA (Single Carrier-Frequency Division Multiple Access).

Layers of a radio interface protocol between a user equipment and a network may be distinguished as a first layer (L1), a second layer (L2), and a third layer (L3), based on three lower layers of a well-known Open System Interconnection (OSI) model in a communication system, and a physical layer of the first layer may provide an information transfer service through use of a physical channel.

In an example of a wireless communication system according to an embodiment of the present invention, a single radio frame may be formed of 10 subframes, and a single subframe may include two slots.

A basic unit for data transmission may be a subframe, and uplink scheduling or downlink scheduling may be performed based on a subframe unit. A single slot may include a plurality of OFDM symbols in a time domain, and may include a plurality of subcarriers in a frequency domain.

For example, a subframe is formed of two time-slots, and when a normal CP (cyclic prefix) is used, each time-slot includes 7 symbols (in the case of an extended CP (cyclic prefix), 6 or 3 symbols) in a time-domain and includes subcarriers corresponding to a bandwidth of 180 kHz in a frequency-domain (a single subcarrier generally includes a bandwidth of 15 kHz and thus, the bandwidth of 180 kHz corresponds to a total of 12 subcarriers). Although a time-frequency domain defined by a single slot in a time axis and a bandwidth of 180 kHz in a frequency axis may be referred to as a resource block (Resource Block; hereinafter referred to as ‘resource block’ or ‘RB’), it may not be limited thereto.

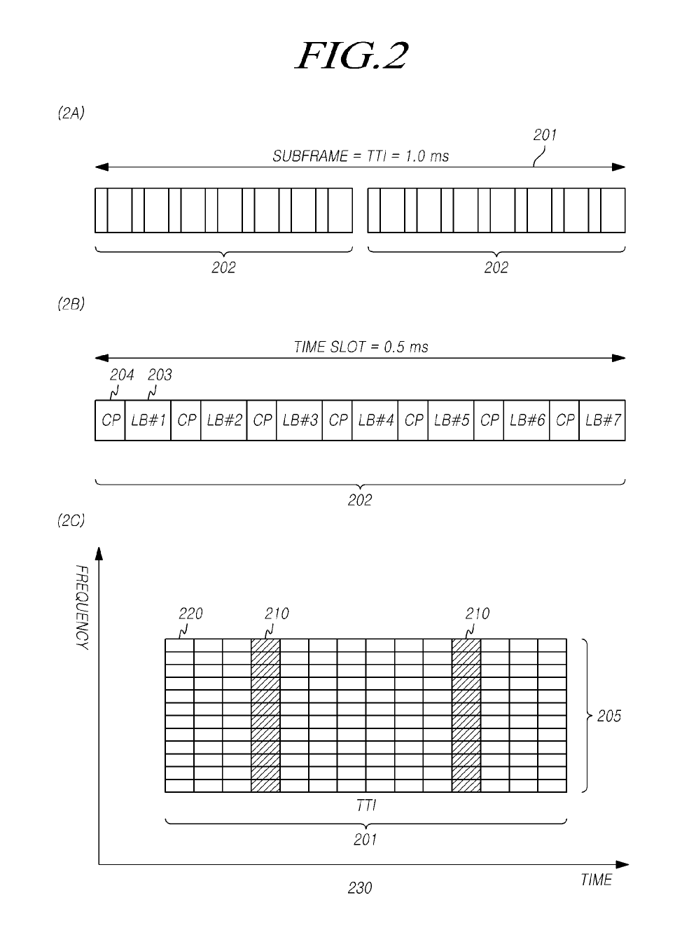

FIG. 2A illustrates a structure of a subframe and a time-slot of transmission data according to an embodiment of the present invention.

Referring to FIG. 2a, a transmission time of a frame is divided into a TTI (transmission time interval) 201 having a duration of 1.0 ms. ‘TTI’ and ‘subframe’ may be directed to the same meaning, and a frame having a length of 10 ms may include 10 TTIs.

FIG. 2b illustrates a general structure of a time-slot according to an embodiment of the present invention.

Referring to FIG. 2b, the TTI may be a basic transmission unit, and a single TTI may include two time-slots 202 of the same length, and each time-slot has a duration of 0.5 ms. The time-slot may include a plurality of long blocks (LB) 203 corresponding to each symbol. The LBs may be separated by cyclic prefixes 204. In this example, the cyclic prefix may be classified into a normal cyclic prefix (Normal CP) and an extended cyclic prefix (Extended CP) based on a length. When the normal cyclic prefix is used, 7 LBs are included in a single time-slot. When the extended cyclic prefix is used, 6 or 3 LBs are included in a single time-slot.

Overall, when a normal cyclic prefix is used, a single TTI or subframe may include 14 LB symbols, and when an extended cyclic prefix is used, a single TTI or subframe may include 12 LB symbols, or 6 LB symbols in a particular case, but the present invention may not be limited to the subframe or the time-slot structure.

FIG. 2c illustrates a configuration of a single resource block (RB) 220 during a single subframe or TTI 201 according to an embodiment of the present invention.

In the case of a normal cyclic prefix, each TTI or subframe is divided into 14 symbols (axes) in a time domain. In the case of an extended cyclic prefix, each TTI or subframe is divided into 12 (or 6) symbols (axes) 210 in the time domain. Each symbol (axis) may carry a single OFDM symbol.

Also, an entire system bandwidth of 20 MHz may be divided into subcarriers 205 having different frequencies. For example, as described above, a region formed of a single slot in a time domain and subcarriers corresponding to a bandwidth of 180 kHz in a frequency domain (generally 12 subcarriers when a subcarrier has a bandwidth of 15 kHz) may be referred to as a resource block.

For example, a bandwidth of 10 MHz in a frequency domain may include 50 RBs within 1 TTI.

Each lattice space forming the resource block is referred to as a resource element (Resource Element; hereinafter referred to as “RE”).

For example, when a normal cyclic prefix is used and a frequency bandwidth per subcarrier is 15 kHz in a resource area corresponding to a single subframe in a time domain and a bandwidth of 180 kHz in a frequency domain, a total of 14(symbols)×12(subcarriers)=168 REs may exist in each resource area having the above structure.

In an LTE communication system, a Cell-specific Reference Signal (CRS), an MBSFN reference signal (Multicast/Broadcast over Single Frequency Network Reference Signal; MBSFN-RS), a UE-specific Reference Signal, a DM-RS (Demodulation Reference Signal), and the like are defined to be a reference signal (RS) in a downlink.

To provide various location services in WCDMA (Wideband Code Division Multiple Access) and location information required for communication, there is a need of measuring a position of a user equipment.

The positioning method is mainly based on the following three methods: 1) a cell coverage-based positioning method, 2) an OTDOA (Observed Time Difference of Arrival) method, and 3) network assisted GPS methods. The methods are supplementary rather than being competitive, and each is appropriately used for a different purpose.

The OTDOA method is based on measuring a position by measuring relative arrival times of reference signals (or pilot) from different base stations or cells, and a reference signal used for this is a positioning reference signal.

Calculating a position is based on triangulation and thus, a UE is required to receive corresponding reference signals from at least three or more different base station cells.

To readily perform OTDOA positioning and to avoid a near-far problem, the WCDMA standard uses IPDL (Idle Periods in Downlink) technology in which a UE is required to receive a reference signal (RS, or pilot) from a neighbor cell during an idle period, although a reference signal from a cell (service cell) where the UE on the same frequency is currently positioned is strong.

Also, an LTE system that is advanced from WCDMA which corresponds to 3GPP series, is based on OFDM (Orthogonal Frequency Division Multiplexing), unlike an asynchronous CDMA scheme of WCDMA. Like positioning through the OTDOA method in WCDMA, the new LTE system currently considers a scheme of measuring a position based on the OTDOA method. For this, a scheme that empties, based on a predetermined period, a data region from each subframe structure of one or both of an MBSFN subframe (Multicast Broadcast Single Frequency Network subframe) and a normal subframe, and sends a reference signal for positioning, that is, a PRS, through the empty region, is taken into consideration.

That is, the system is based on the OTDOA scheme in WCDMA, but a communication scheme such as a multiplexing scheme, an access scheme, and the like is changed. Accordingly, for positioning in LTE corresponding to an OFDM-based next generation communication scheme, a method of sending a reference signal for positioning in a new resource allocation structure and a configuration of the reference signal is required to be renewed. Also, there is a desire for a more accurate positioning method due to development of a communication system such as an increase in movement speed of a UE, a change in interference environment between base stations, an increase in complexity, and the like.

Therefore, currently, LTE configures a positioning reference signal and determines a transmission and reception scheme of the Release 9 version, by taking the above cases into consideration.

One of the situations to be considered in a communication system after LTE Release 9 version, advanced by supplementing disadvantages of LTE corresponding to the OFDM-based next generation communication scheme, and taking into consideration various cases for improvement of performance, is a heterogeneous communication environment including a plurality of macro cells and different types of base stations, such as one or more pico cells or femto cells, included in predetermined macro cells. As another example of the heterogeneous communication environment, there is a communication system including a plurality of macro cells at a CoMP (Coordinated Multi-Point) and one or more RRHs included in predetermined macro cells. In the heterogeneous communication environment, when a positioning reference signal is defined by a conventional scheme that takes into consideration merely a macro cell, a reception error probability of the positioning reference signal may increase due to interference from different types of base stations such as a pico cell and the like.

In particular, when PRS transmission of a non-macro cell such as a pico cell is not defined in the heterogeneous communication environment, a definition of a macro cell is applied to the pico cell since the pico cell also functions as an independent cell. In this example, a user equipment receives PRSs from the macro cell and the pico cell and thus, positioning may be impossible due to PRS signal interference between the macro cell and the pico cell.

Therefore, there is provided a PRS muting method and device, so as to maximally decrease an effect of interference between different types of base stations and to improve accuracy of positioning for a UE, in the heterogeneous communication environment including a plurality of macro cells and one or more different types of base stations such as pico cells included in predetermined macro cells.

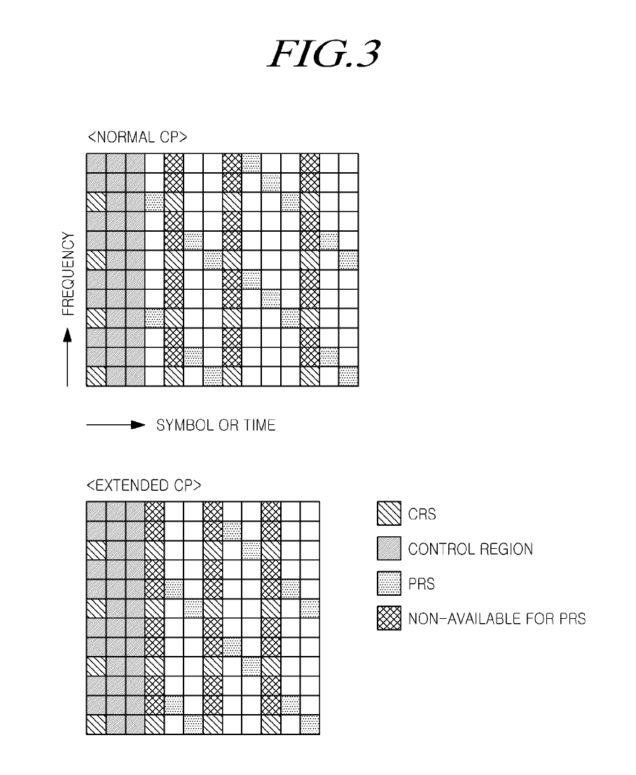

FIG. 3 illustrates a positioning reference signal pattern of a communication system that takes merely a macro cell into consideration.

The PRS pattern is defined by a single subframe (corresponding to 1 ms) in a time axis and a single resource block (corresponding to a bandwidth of 180 kHz, and generally, corresponding to 12 subcarriers when a bandwidth per subcarrier is 15 kHz) in a frequency axis.

As illustrated in FIG. 3, a positioning reference signal is transmitted by emptying a data region excluding a control region and a CRS (Cell-specific Reference Signal), and an RE to which a pattern for the positioning reference signal, that is, a PRS sequence, is allocated may be shifted in a frequency axis. Therefore, a positioning reference signal is transmitted based on a pattern different for each of up to 6 base station (cell) groups. That is, each of the base stations (cells) may transmit a positioning reference signal based on one of a total of 6 patterns at a predetermined time, and a corresponding user equipment for measuring each positioning reference signal may measure a position by receiving a positioning reference signal from each base station at a predetermined time.

The frequency shift is based on a base station (cell) number or an ID, and a total number of patterns is only 6 and thus, a method of reducing interference between neighbor base stations (cells) is used by adjusting neighbor base stations (cells) not to use an identical pattern as far as possible through appropriate distribution of a base station (cell) number or ID, that is, by performing cell planning.

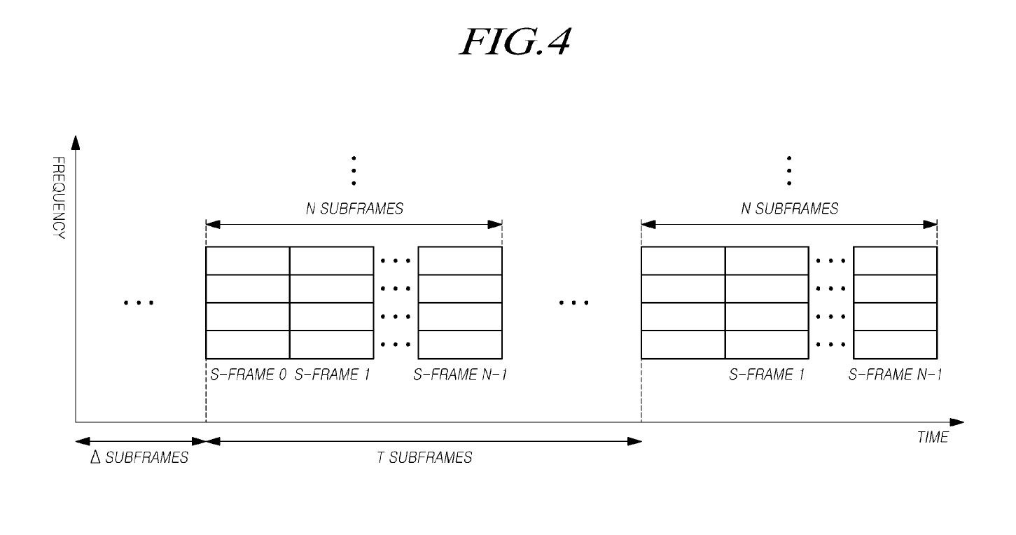

FIG. 4 illustrates a transmission scheme of a positioning reference signal.

As illustrated in FIG. 4, a positioning reference signal is transmitted in N successive subframes having a predetermined period (T subframes). In this example, the predetermined period may be one of 160 ms, 320 ms, 640 ms, and 1280 ms (1 ms corresponds to a single subframe and thus, when a period is, for example, 160 ms, a positioning reference signal is transmitted every 160 subframes), and information or a value associated with the predetermined period may be signaled from a higher layer in a form of being coupled with a predetermined offset value.

Therefore, when the predetermined period is T_{PRS}, the predetermined offset value is [symbol] _{PRS}, the value signaled from the higher layer is I_{PRS}, and the N successive subframes are N_{PRS}, a positioning reference signal may be transmitted in N_{PRS} successive subframes from a subframe that satisfies the following Equation 1.

(10×n_{f}+└nₛ/2┘− [symbol] _{PRS})mod T_{PRS}=0 [Equation 1]

In this example, T_{PRS} is one of 160, 320, 640, and 1280, and [symbol] _{PRS} has a value from 0 to T_{PRS}−1. Also, I_{PRS} is expressed by a value of a total of 12 bits (a value from 0 to 4095). I_{PRS} Of 0˜159 expresses the case of T_{PRS}=160 and an offset value [symbol] _{PRS} of the case, I_{PRS} Of 160˜497 expresses the case of T_{PRS}=320 and an offset value [symbol] _{PRS} of the case, I_{PRS} Of 480˜1119 expresses the case of T_{PRS}=640 and an offset value [symbol] _{PRS} of the case, and I_{PRS} Of 1120˜2399 expresses the case of T_{PRS}=1280 and an offset value [symbol] _{PRS} of the case. N_{PRS} is also a value transmitted from the higher layer and may correspond to one of 1, 2, 4, and 6. Also, n_{f} corresponds to a system frame number, and nₛ corresponds to a slot number.

For example, in the case of N_{PRS}=4 and I_{PRS}=200 which are signaled from the higher layer, it corresponds to T_{PRS}=320 and [symbol] _{PRS}=40 and thus, a positioning reference signal is transmitted in 4 successive subframes of every 320 subframes with an offset of 40 subframes.

In this example, not all base stations (cells) transmit positioning reference signals but predetermined base stations (cells) transmit positioning reference signals in subframes formed to transmit positioning reference signals. However, the remaining base stations (cells) that do not transmit positioning reference signals may perform muting or blanking, that is, zero-power transmission, in the subframes formed for predetermined base stations (cells)'s transmission of positional references. This is one of the methods for reducing an effect of interference by taking into consideration the case where a plurality of neighbor base stations (cells) having an identical reference signal pattern exists.

Here, muting may be performed for each transmission period (T_{PRS}) of a positioning reference signal. Whether to perform transmission of a positioning reference signal or to perform muting with respect to N_{PRS} subframes formed to transmit a positional reference within a period is determined by considering each transmission period (T_{PRS}) as a single bit and considering 2, 4, 8, or 16 periods as bitmap information. The bitmap information is formed for each base station (cell), and is transmitted from a higher layer.

For example, when the bitmap information is formed of bitmap information of 4 bits with respect to 4 periods and a bit value is ‘1001’ (the bitmap information is formed using 1 defined to be a poisoning reference signal transmission and 0 defined to be muting, or using 0 defined to be a positioning reference signal transmission and 1 defined to be muting), a positioning reference signal is transmitted in N_{PRS} subframes formed to transmit a positional reference within a first and fourth positioning reference signal transmission periods, and muting corresponding to zero-power transmission is performed, as opposed to transmitting a positioning reference signal, with respect to N_{PRS} subframes formed to transmit a positional reference within a second and third positioning reference signal transmission periods.

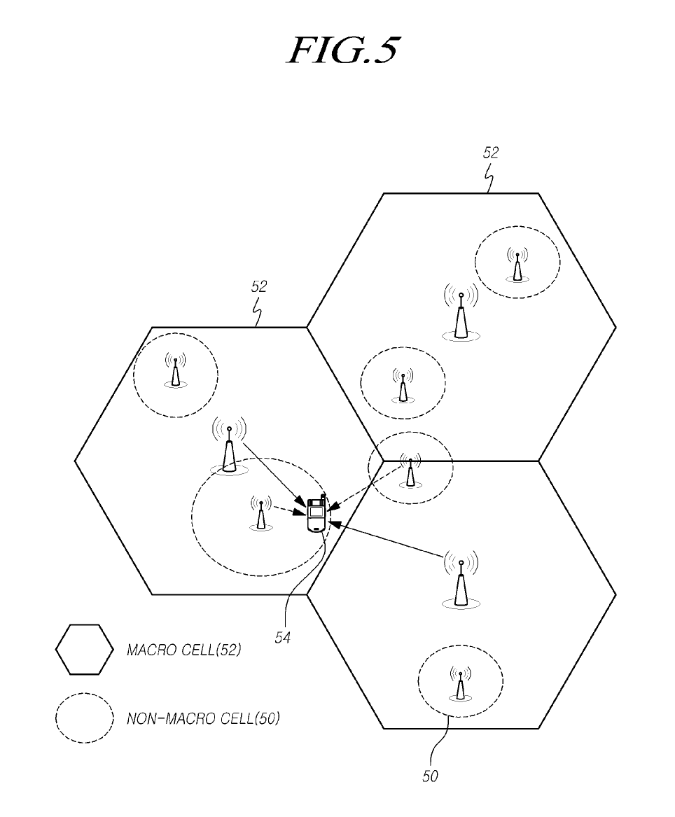

FIG. 5 illustrates a positioning reference signal transmission status in a heterogeneous communication environment according to the present invention.

As illustrated in FIG. 5, non-macro cells 50, such as a pico cell or a femto cell, may exist in respective macro cells 52. In this example, a user equipment 54 included in a predetermined non-macro cell may receive a signal from a macro cell in addition to the non-macro cell.

In FIG. 5, signal transmission from a non-macro cell is expressed by a broken line, and signal transmission from a macro cell is expressed by a solid line.

In the present specifications, a non-macro cell generally means a pico cell, but it is not limited thereto, and it may be construed as an inclusive term indicating all types of “non-macro cell” positioned in a “macro cell” corresponding to a base station or a cell of a general communication system, such as a femto cell, a micro cell, an RRH, and the like in addition to the pico cell.

Therefore, as described above, when a positioning reference signal is defined by taking into consideration merely a macro cell, a reception error probability of the positioning reference signal may increase due to interference from different types of base stations such as a pico cell and the like.

In particular, when PRS transmission of a non-macro cell such as a pico cell is not defined in a heterogeneous communication environment, a definition of a macro cell is applied to the pico cell since the pico cell also functions as an independent cell. In this example, a user equipment receives PRSs from the macro cell and the pico cell and thus, positioning may be impossible due to PRS signal interference between the macro cell and the pico cell.

Therefore, a positioning reference signal muting method and device are provided, that maximally decrease an effect of interference between different types of base stations and improve accuracy of positioning for UE, in the heterogeneous communication environment including a plurality of macro cells and one or more different types of non-macro cells (base stations) such as pico cells included in predetermined macro cells.

According to a positioning reference signal muting method of the present invention, in a heterogeneous communication system including one or more macro cells and one or more non-macro cells positioned in each macro cell, the non-macro cells do not separately transmit position reference signals, and perform muting, that is, do not perform data transmission, in a time-frequency resource area where one or more predetermined macro cells from among the macro cells transmit positioning reference signals.

Here, the ‘predetermined macro cell’ may correspond to all of the macro cells, or may be defined to be a macro cell of which a corresponding non-macro cell is positioned in its cell area and a neighbor macro cell thereof.

In this example, when a non-macro cell determines an area for muting, information associated with a resource area in which a macro cell transmits a positioning reference signal is required, and the information is defined to be ‘muting information’, ‘PRS muting information’, or ‘PDSCH muting information’ in the present invention. The ‘PRS muting information’ is information which enables a neighbor cell having a different type to not transmit a PRS in a resource area identical to a resource area in which a predetermined cell transmits a PRS, but to perform muting, so as to overcome interference occurring when the neighbor cell (herein, a non-macro cell) transmits a PRS to the resource area identical to the resource area in which the corresponding predetermined cell (herein, a macro cell) transmits a PRS. The ‘PDSCH muting information’ is information which enables a neighbor cell having a different type to not perform data transmission through a PDSCH resource area with respect to a resource area identical to a resource area in which a predetermined cell transmits a PRS, but to perform muting, so as to overcome interference occurring when the neighbor cell (herein, a non-macro cell) performs data transmission through a PDSCH resource area to the resource area identical to the resource area in which the corresponding predetermined cell (herein, a macro cell) transmits a PRS. In the present invention, muting information may be used only when two meanings of muting do not cause confusion and thus, the muting information may be mixed with PRS muting information or PDSCH muting information.

The muting information may include one or more of a PRS transmission period (T) of a macro cell, a PRS transmission offset (Δ), a number of PRS transmission subframes (N), PRS transmission activation information (bitmap information and the like), and a PRS pattern. The muting information may be known by a pico cell in advance, or may be signaled from one or more macro cells or from a higher layer.

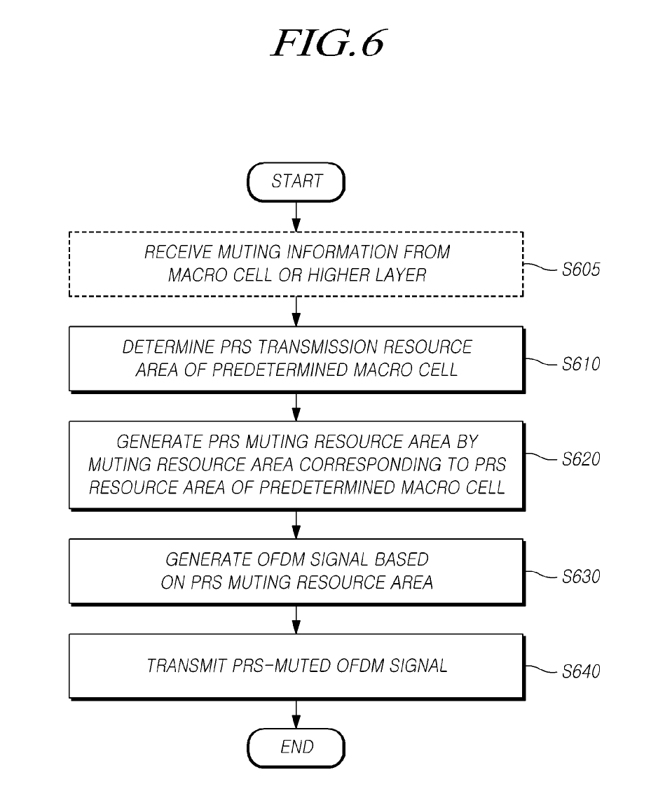

Hereinafter, details of various embodiments will be described with reference to FIGS. 6 through 10.

Although a pico cell is described as an example of a non-macro cell in the following descriptions, it is construed as an inclusive term indicating all types of “non-macro cell” positioned in a “macro cell” corresponding to a base station or a cell in a general communication system, as described above.

FIG. 6 is a flowchart illustrating a PRS muting method according to an embodiment of the present invention.

A PRS muting method according to an embodiment of the present invention, which is a PRS muting method in a communication system including one or more macro cells and one or more pico cells included in the macro cells, includes a step S610 in which the non-macro cell determines a PRS transmission resource area of one or more predetermined macro cells from among the macro cells, a step S620 of generating a PRS muting resource area by muting a resource area corresponding to a PRS transmission resource area of the predetermined macro cell during resource allocation, a step S630 of generating an OFDM signal by taking the PRS muting resource area into consideration, and a step S640 of transmitting the generated OFDM signal.

Also, the method may further include a step S605 of receiving, from the predetermined macro cell or a higher layer, muting information that is used for determining the PRS transmission resource area of the predetermined macro cell, before step S610. In this example, the muting information may be received through an RRC (Radio Resource Control) signaling and the like, but it may not be limited thereto.

The muting information, which is information used for determining a time-frequency resource area in which the predetermined macro cell transmits a PRS, may include one or more of a PRS transmission period (T), a PRS transmission offset (Δ), a number of PRS transmission subframes (N), a period-based PRS transmission activation information (bitmap information and the like), and a PRS pattern, but it may not be limited thereto.

The PRS muting resource area (a resource area in which the predetermined macro cell transmits a PRS) that the pico cell generates in step S620 includes the case of muting all PRS patterns through which a macro cell is capable of transmitting a PRS, and the case of muting a few specific patterns from among possible PRS patterns. A number of currently defined possible PRS patterns is a total of 6 as illustrated in FIG. 3, but it may not be limited thereto.

The present invention includes two embodiments based on a PRS muting scheme of a pico cell.

### A First Embodiment

### A Scheme of Muting PRS-Allocated REs of all PRS Pattern (6)

In the first embodiment, a pico cell performs muting with respect to all PRS patterns.

In the first embodiment, a macro cell basically performs cell planning and distributes 6 PRS patterns based on a conventional scheme so that neighbor macro cells do not have an identical PRS pattern as far as possible.

The pico cell does not separately transmit a PRS, and does not transmit data but performs muting with respect to a time-frequency resource area in which a predetermined macro cell transmits a PRS. In the first embodiment, muting is performed with respect to PRS patterns of all macro cells.

Macro cells may have different PRS transmission offset values from each other in an environment based on an asynchronous (Asynchronization) scheme. However, in terms of time, the macro cells may generally transmit PRSs at an identical time period and thus, the first embodiment takes into consideration PRS patterns of all macro cells. That is, pico cells do not data transmission and perform muting when the macro cells transmit PRSs with respect to a total of 6 PRS patterns.

Therefore, pico cells included in a macro cell may know about muting information of the corresponding macro cell, that is, a PRS transmission period of the macro cell, a transmission offset, a number of transmission subframes, or may receive the muting information from the macro cell or from a higher layer through signaling. Based on the muting information, the pico cells may perform muting and may not perform data transmission based on the above scheme with respect to common PRS transmission subframes of the macro cell.

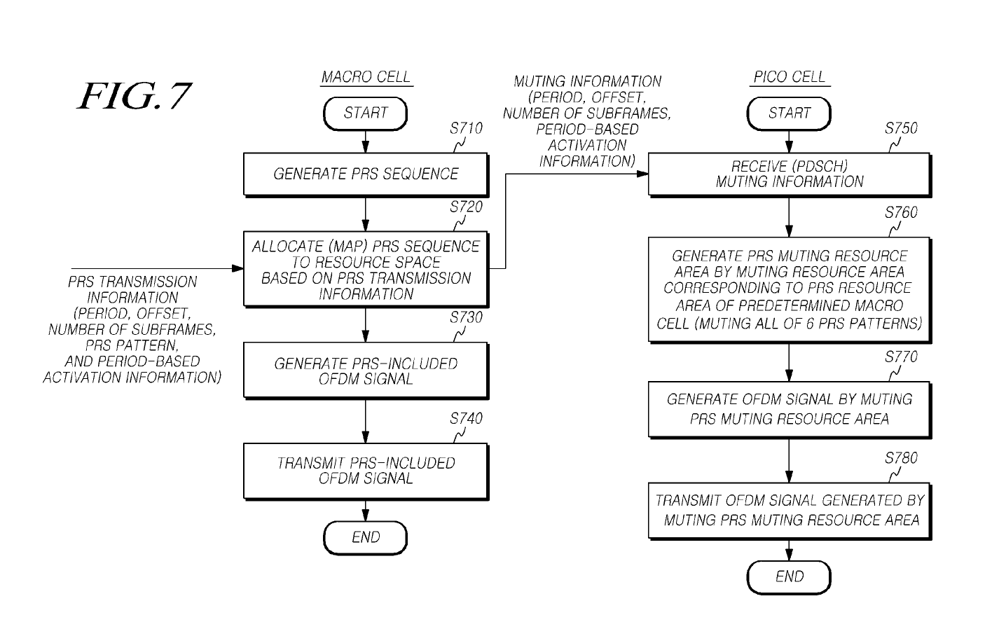

FIG. 7 is a flowchart illustrating a PRS muting method according to the first embodiment of the present invention, and illustrates a PRS transmission operation of a macro cell and a PRS muting operation of a pico cell.

Although FIG. 7 illustrates that muting information is transmitted or signaled from a macro cell to a pico cell, it is merely an example, and as described above, the pico cell knows in advance about the muting information or the muting information may be transmitted from a higher layer such as a separate RRC, as opposed to a macro cell.

As illustrated in an embodiment of FIG. 7, in a communication system including one or more macro cells or one or more pico cells included in the macro cells, operations performed by a macro cell include a step S710 of generating a cell-specific PRS sequence, a step S720 of allocating or mapping the generated PRS sequence to a time-frequency resource space based on the PRS transmission information, a step S730 of generating an OFDM signal including the allocated or mapped PRS sequence, and a step S740 of transmitting the generated OFDM signal.

The PRS transmission information used for allocating or mapping the PRS sequence to the resource space in step S720 may include a PRS pattern, a number of PRS transmission subframes, a PRS transmission period and transmission offset, a period-based PRS transmission activation information (bitmap information), and the like, but this may not be limited thereto. The PRS transmission information may be transmitted for each base station or for each cell by a higher layer through an RRC, but it may not be limited thereto.

A process of allocating or mapping the PRS sequence to the time-frequency resource space may interwork with or may be included in resource element mapping with respect to other information (data or a control signal and the like). That is, this may correspond to a process of selecting (allocating) REs for a PRS sequence from among all REs that are targets of resource element mapping (this corresponds to a PRS pattern), and mapping a generated PRS sequence to the REs.

In this example, the macro cell may transmit a corresponding PRS in N successive subframes based on a corresponding PRS transmission period (T) and PRS transmission offset (Δ), and may perform PRS transmission or may perform muting as opposed to transmitting a PRS for each period, based on higher layer bitmap information in which a single bit is used for a single period, that is, period-based PRS transmission activation information.

For example, when bitmap information (period-based PRS transmission activation information) signaled from a higher layer for PRS transmission of a macro cell is ‘1001’ (it is assumed that 1 indicates transmission and 0 indicates muting. Of course, a reverse case is also available), for 4 periods, the macro cell transmits a PRS with respect to 1^{st} and 4^{th} periods and may not transmit a PRS and instead perform muting with respect to 2^{nd} and 3^{rd} periods.

In the present invention, to distinguish from PRS muting information that a pico cell uses for PRS muting and PDSCH muting information (a PRS period, an offset, a number of transmission subframes, and the like for macro cells), information based on which the macro cell transmits a PRS or does not transmit a PRS for each PRS period (bitmap information transmitted from a higher layer—each bit corresponding to each PRS transmission period) is expressed as “period-based PRS transmission activation information.” However, this may not be limited to the term, and may be expressed by another term or an expression having a technically or functionally equivalent concept.

Operations performed by a pico cell include a step S750 of receiving muting information, particularly, PDSCH muting information or PRS muting information from a macro cell or through a higher layer signaling, or generating the muting information, a step S760 of generating a PRS muting resource area by performing PDSCH muting or PRS muting based on the muting information, a step S770 of generating an OFDM signal based on the PRS muting resource area, and a step S780 of transmitting the generated OFDM signal.

The muting information receiving or generating step in step S750 corresponds to a process in which a pico cell receives muting information of a predetermined macro cell including a number of PRS transmission subframes, a PRS transmission period, a transmission offset, period-based PRS transmission activation information, and the like.

Based on the received muting information, a portion where the corresponding pico cell does not transmit data (corresponding to a PDSCH) and instead performs zero-power transmission so as to exclude interference by taking into consideration PRS transmission of a predetermined macro cell, that is, a PRS muting resource area, may be determined.

In this example, the predetermined macro cell is a macro cell where accurate positioning of a user equipment is difficult due to interference occurring when a pico cell transmits a PRS. In general, a macro cell including the corresponding pico cell is the predetermined macro cell, but this may not be limited thereto. Another macro cell such as a neighbor macro cell of the macro cell including the corresponding pico cell and the like may be the predetermined macro cell.

Also, the muting information in the first embodiment may include a number of PRS transmission subframes of a predetermined macro cell, a PRS transmission period, a transmission offset, and a period-based PRS transmission activation information (bitmap information), but excludes a PRS pattern.

Also, the muting information is generally transmitted from a predetermined macro cell or another macro cell, but this may not be limited thereto. The muting information may be set in advance in a pico cell, or may be transmitted to a pico cell through a higher layer signaling such as an RRC. Particularly, when the muting information is directly transmitted to a pico cell through the immediately higher layer RRC information, the higher layer may transmit identical information (muting information) to the corresponding macro cell and to all pico cells included in the corresponding macro cell.

The PRS muting resource area that a pico cell generates in step S760 of the first embodiment mutes all REs to which a PRS may be allocated from among a total of 6 PRS patterns that a macro cell is capable of using, and this may be because signaled muting information does not include information associated with a PRS pattern.

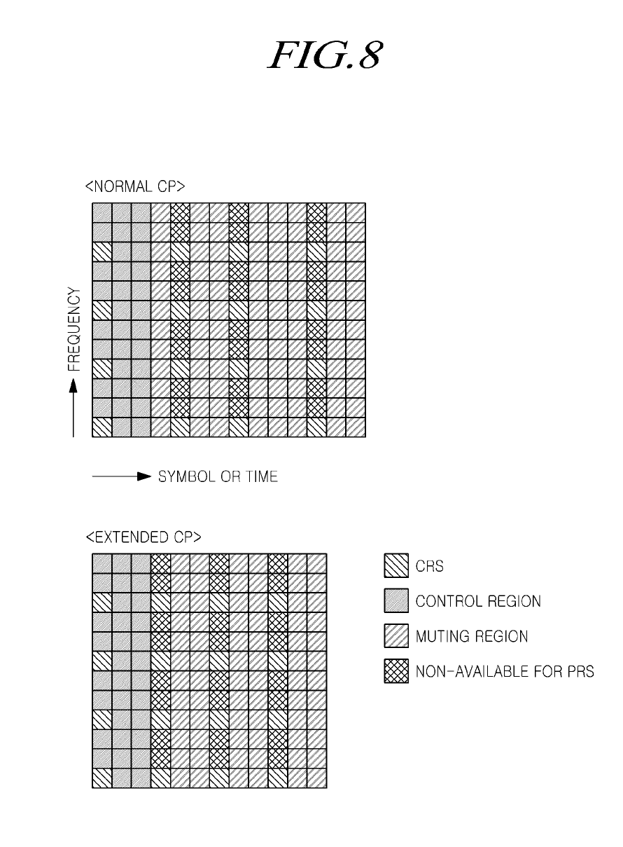

FIG. 8 illustrates an example of a PRS muting resource area that a pico cell generates based on muting information in the first embodiment of FIG. 7

As illustrated in FIG. 8, in the first embodiment, when a PRS muting resource area generated by a pico cell is checked based on an RB unit, all REs to which a PRS sequence may be allocated through a total of 6 PRS patterns in a PRS-included resource area as shown in FIG. 3 may be muted.

That is, in the case of a PRS transmission subframe having a normal CP, all REs to which a total of 6 PRS patterns may be allocated, that is, all REs positioned in symbol axes of which symbol numbers (1) are 3, 5, 6, 8, 9, 10, 12, and 13 may be muted. In the case of a PRS transmission subframe having an extended CP, all REs positioned in symbol axes of which symbol numbers (1) are 4, 5, 7, 8, 10, and 11 may be muted.

In terms of a time domain where a pico cell performs PRS muting, generally, a pico cell performs PRS muting in all periods of PRS transmission subframes formed for a predetermined macro cell to transmit a PRS. However, as described above, when a predetermined macro cell transmits a PRS in a predetermined period using period-based PRS transmission activation information (bitmap information), a pico cell may perform PRS muting with respect to only a PRS transmission subframe of a period where PRS transmission is activated.

Generating a PRS muting resource area or PRS muting in step S760 may be expressed as ‘PDSCH muting’, and the PDSCH muting may be embodied by interworking with or being included in resource element mapping that a pico cell (base station device) originally has. That is, it may be performed by selecting (allocating) REs to be muted for excluding interference in consideration of PRS transmission of a predetermined macro cell, from among all REs that are targets of resource element mapping, and mapping zero-power with respect to the REs as opposed to mapping data (corresponding to a PDSCH).

Therefore, an OFDM signal transmitted by a macro cell in step S740 of the first embodiment corresponds to a signal generated through allocation of a PRS sequence, and an OFDM signal transmitted by a pico cell in step S780 corresponds to a signal generated through muting of corresponding REs of all PRS patterns that a macro cell is capable of using.

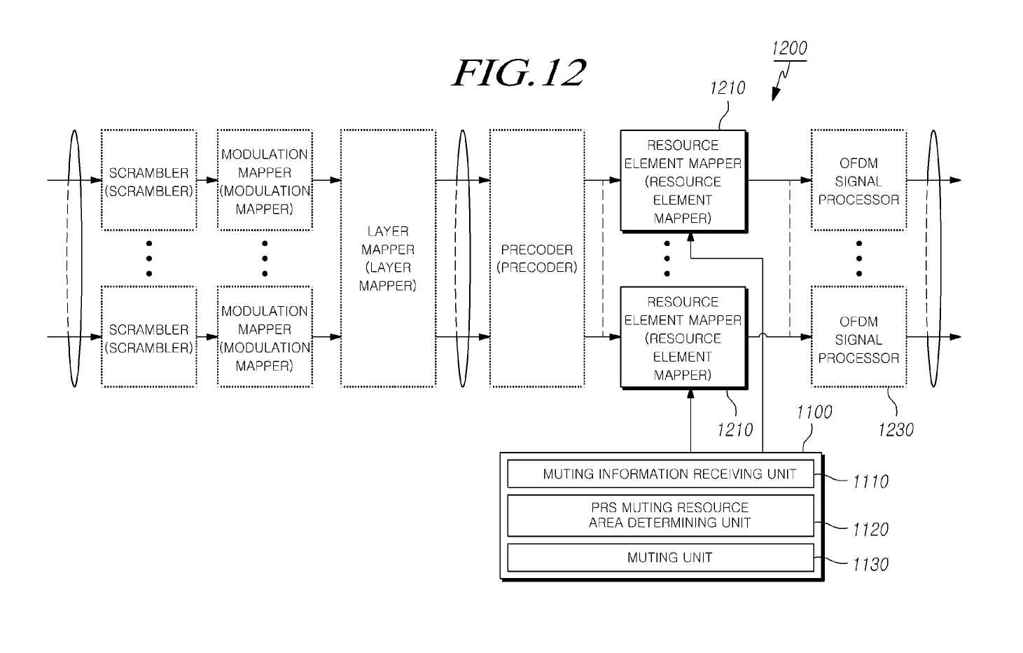

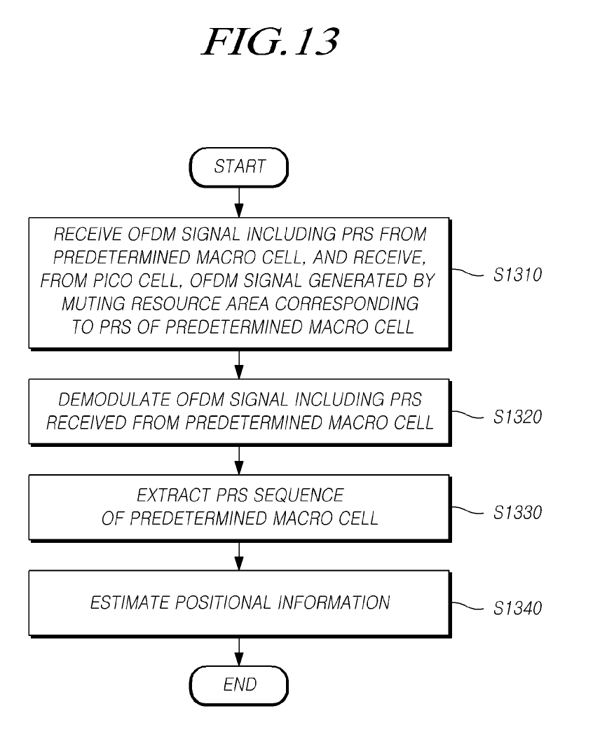

A user equipment may demodulate an OFDM signal of a macro cell based on the above process, may extract a PRS sequence, may calculate a distance between the corresponding macro cell and the user equipment, and may estimate a position based on three or more pieces of distance information (the positioning process will be described in detail with reference to FIG. 12 and FIG. 13.)

### A Second Embodiment

### A Scheme of Muting Only a PRS-Allocated RE of a Predetermined PRS Pattern (<6)

The second embodiment is a scheme of muting only a PRS-allocated RE with respect to a predetermined number (N<6) of PRS patterns, unlike the first embodiment in which a pico cell performs muting with respect to all PRS patterns.

In this example, a predetermined PRS pattern that performs muting is a PRS pattern that is used by a predetermined macro cell that is required to avoid interference since it is used for measuring a position of a user equipment.

A predetermined macro cell generally corresponds to a macro cell including a corresponding pico cell that performs PRS muting, but this may not be limited thereto and the predetermined macro cell may be one or more macro cells neighboring the macro cell.

In the second embodiment, cell planning is performed to distribute a total of 6 PRS patterns so that neighbor macro cells do not have an identical PRS pattern as far as possible, in the same manner as the first embodiment.

A pico cell may not transmit a PRS separately, and performs muting as opposed to transmitting data with respect to a corresponding time-frequency resource area in which a predetermined macro cell transmits a PRS, and in the second embodiment, the muting is performed with respect to one or more predetermined PRS patterns as opposed to PRS patterns of all macro cells.

Each macro cell has a different PRS transmission offset value in an environment based on an asynchronous scheme. However, in terms of time, each macro cell generally transmits a PRS at an identical time period. Therefore, in the second embodiment, a pico cell may not transmit data and performs muting with respect to only a PRS pattern that a predetermined macro cell uses only for a PRS transmission subframe at which the predetermined macro cell actually transmits a PRS.

Accordingly, pico cells included in the corresponding macro cell may know in advance about muting information of the macro cell to which the pico cells belong, that is, a PRS transmission period of the macro cell, a transmission offset, a number of transmission subframes, and PRS pattern information, or may receive the muting information from the macro cell or a higher layer through signaling. Based on the muting information, the pico cells do not transmit data and perform muting, based on the above scheme, with respect to only a predetermined PRS pattern for PRS transmission subframes of the predetermined macro cell.

That is, a difference between the first embodiment and the second embodiment is whether a pico cell receives PRS pattern information from a macro cell and the like and reflects the information to PRS muting. The second embodiment is different from the first embodiment in that the second embodiment receives PRS pattern information that a predetermined macro cell uses, and performs muting with respect to only an RE that corresponds to the PRS pattern.

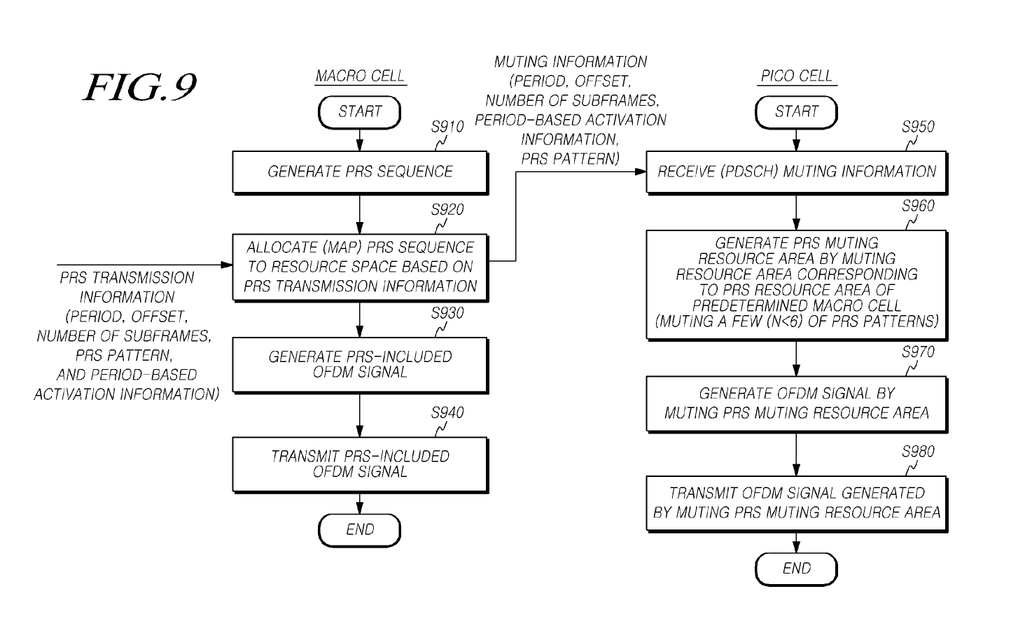

FIG. 9 is a flowchart illustrating a PRS muting method according to the second embodiment of the present invention, and illustrates a PRS transmission operation of a macro cell and a PRS muting operation of a pico cell.

Although FIG. 9 illustrates that muting information including PRS pattern information is transmitted or signaled from a macro cell to a pico cell, it may not be limited thereto. Like the first embodiment, the pico cell may know in advance about the muting information, or may be received from a separate higher layer such as an RRC as opposed to a macro cell.

In the second embodiment, a macro cell operates as follows.

Similar to an embodiment of FIG. 7, in a communication system including one or more macro cells and one or more pico cells included in the macro cells, operations performed by the macro cell include a step S910 of generating a cell-specific PRS sequence, a step S920 of allocating or mapping the generated PRS sequence to a time-frequency resource space using PRS transmission information, a step S930 of generating an OFDM signal including the allocated or mapped PRS sequence, and a step S940 of transmitting the generated OFDM signal.

The PRS transmission information used for allocating or mapping the PRS sequence to the resource space in step S920 may include a PRS pattern, a number of PRS transmission subframes, a PRS transmission period and transmission offset, a period-based PRS transmission activation information (bitmap information), and the like, but this may not be limited thereto. The PRS transmission information may be transmitted for each base station or for each cell by a higher layer through an RRC, but it may not be limited thereto.

A process of allocating or mapping the PRS sequence to the time-frequency resource space may interwork with or may be included in resource element mapping with respect to other information (data or a control signal and the like). That is, this may correspond to a process of selecting (allocating) REs for a PRS sequence from among all REs that are targets of resource element mapping (this corresponds to a PRS pattern), and mapping a generated PRS sequence to the REs.

In this example, the macro cell may transmit a corresponding PRS in N successive subframes based on a corresponding PRS transmission period (T) and PRS transmission offset (Δ), and may perform PRS transmission or may perform muting as opposed to transmitting a PRS for each period, based on higher layer bitmap information (period-based PRS transmission activation information) in which a single bit is used for a single period, as described in the first embodiment.

Other operations of a macro cell are equal to the first embodiment of FIG. 7 and thus, detailed descriptions thereof will be omitted for avoiding redundancies.

In the second embodiment, operations performed by a pico cell include a step S950 of receiving muting information, particularly, PDSCH muting information or PRS muting information, through a macro cell or higher layer signaling, or generating the muting information, a step S960 of generating a PRS muting resource area by performing PDSCH muting or PRS muting based on the muting information, a step S970 of generating an OFDM signal by taking the PRS muting resource area into consideration, and a step S980 of transmitting the generated OFDM signal.

The muting information receiving or generating step in step S950 corresponds to a process of receiving muting information including a number of PRS transmission subframes of a predetermined macro cell, a PRS transmission period, a transmission offset, and a period-based PRS transmission activation information (bitmap information), together with PRS pattern information of the predetermined macro cell which differentiates the present embodiment from the first embodiment.

Based on the received muting information, a portion where the corresponding pico cell does not transmit data (corresponding to a PDSCH) and performs zero-power transmission so as to exclude interference by taking into consideration PRS transmission of a predetermined macro cell, that is, a PRS muting resource area, may be determined.

Also, the muting information is generally transmitted from a predetermined macro cell or another macro cell, but this may not be limited thereto. The muting information may be set in advance in a pico cell, or may be transmitted to a pico cell through a higher layer signaling such as an RRC. Particularly, when the muting information is directly transmitted to a pico cell through the immediately higher layer RRC information, the higher layer may transmit identical information (muting information) to the corresponding macro cell and to all pico cells included in the corresponding macro cell.

The PRS muting resource area that a pico cell generates in step S960 of the second embodiment performs muting with respect to only a PRS-allocated RE of 1 or N (N<6) PRS patterns that a predetermined macro cell uses, which is a configuration different from the first embodiment.

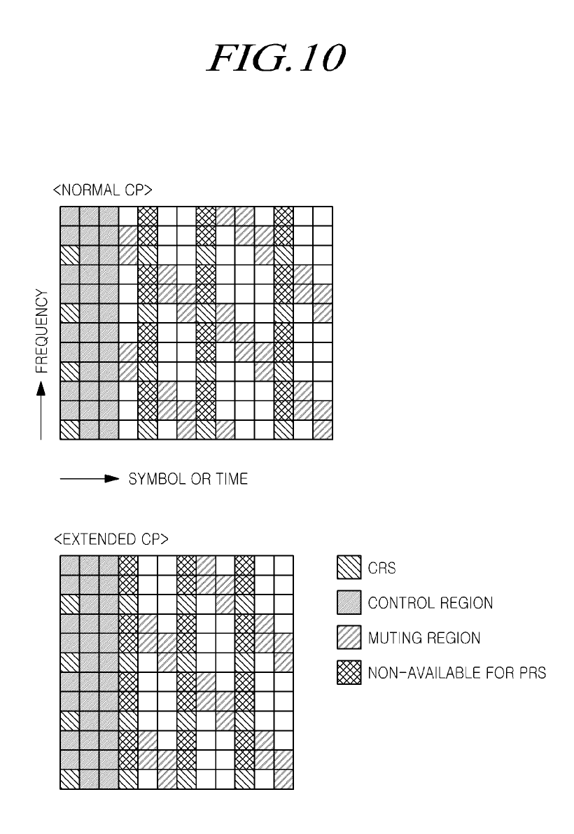

FIG. 10 illustrates an example of a PRS muting resource area that is generated by a pico cell based on muting information in the second embodiment of FIG. 9.

As illustrated in FIG. 10, in the second embodiment, when a PRS muting resource area is checked based on an RB unit, a PRS-allocated RE (FIG. 10 shows an example that takes into consideration only PRS patterns of 2 macro cells) of a predetermined PRS pattern that a predetermined macro cell uses from among a total of 6 PRS patterns in a PRS-included resource area as shown in FIG. 3 may be muted.

That is, in the case of a PRS transmission subframe having a normal CP or an extended CP in FIG. 10, PRS allocated REs of 2 (that is, N=2) PRS patterns from among 6 PRS patterns, that is, REs marked with black, may be muted.

In terms of a time domain where a pico cell performs PRS muting, generally, a pico cell performs PRS muting in all periods of PRS transmission subframes formed for a predetermined macro cell to transmit a PRS. However, as described above, when a predetermined macro cell transmits a PRS in a predetermined period using period-based PRS transmission activation information (bitmap information), a pico cell may perform PRS muting with respect to only a PRS transmission subframe of a period where PRS transmission is activated.

Generating a PRS muting resource area or PRS muting in step S960 may be expressed as ‘generating of PDSCH muting resource area’ or ‘PDSCH muting’, and the PDSCH muting may be embodied by interworking with or being included in resource element mapping that a pico cell (base station device) originally has. That is, it may be performed by selecting (allocating) REs to be muted for excluding interference in consideration of PRS transmission of a predetermined macro cell, from among all REs that are targets of resource element mapping, and mapping zero-power with respect to the REs as opposed to mapping data (corresponding to a PDSCH).

Therefore, an OFDM signal transmitted by a macro cell in step S940 of the second embodiment corresponds to a signal generated through allocation of a PRS sequence, and an OFDM signal transmitted by a pico cell in step S980 corresponds to a signal generated through muting of corresponding REs of 1 or N (N<6) PRS patterns that a predetermined macro cell may use.

A user equipment may demodulate an OFDM signal of a macro cell based on the above process, may extract a PRS sequence, may calculate a distance between the corresponding macro cell and the user equipment, and may estimate a position based on three or more pieces of distance information (the positioning process will be described in detail with reference to FIG. 12 and FIG. 13.)

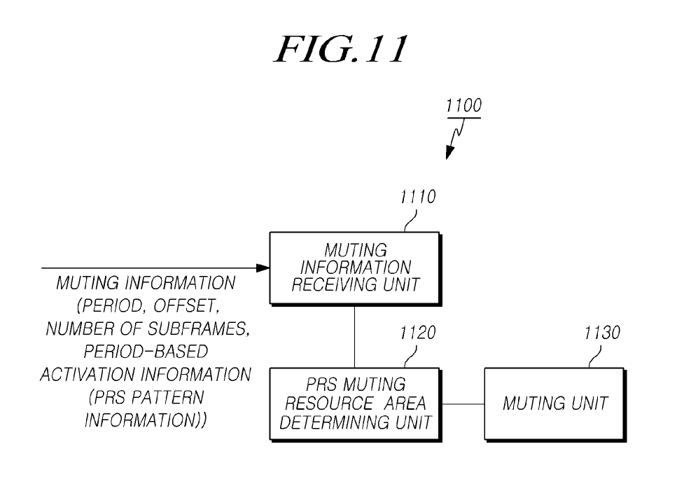

FIG. 11 is a block diagram illustrating a PRS muting device that performs PRS muting according to an embodiment of the present invention

The PRS muting device according to an embodiment of the present invention is generally embodied in a pico cell device, but this may not be limited thereto, and may be embodied as a separate device interworking with a pico cell.

A PRS muting device 1100 according to an embodiment includes a muting information receiving unit 1110, a PRS muting resource area determining unit 1120, and a muting unit 1130.

The muting information receiving unit 1110 performs a function of receiving muting information (or PRS muting information or PDSCH muting information) required for PRS muting, from a predetermined macro cell or from a component of a higher layer. As described above, the muting information may include a number of PRS transmission subframes of one or more macro cells that transmit PRSs, a PRS transmission period, a transmission offset, period-based PRS transmission activation information (bitmap information), and the like, and may selectively include PRS pattern information of a corresponding cell (that is, the first embodiment excludes the PRS pattern information and the second embodiment includes the PRS pattern information).

The PRS muting resource area determining unit 1120 performs a function of determining a time-frequency resource area in which a predetermined macro cell transmits a PRS, that is, an RE in which muting is to be performed, based on the received muting information. That is, the first embodiment determines, as a muting area, PRS-allocated REs of all of 6 PRS patterns based on which a macro cell is capable of transmitting a PRS from among resource blocks of a subframe in which a predetermined macro cell transmits a PRS, whereas the second embodiment determines, as a muting area, a PRS-allocated RE of a PRS pattern that a predetermined macro cell (e.g., a macro cell including itself) uses from among 6 PRS patterns.

A muting unit 1130 performs a function of not allocating data or allocating a resource for zero-power transmission, with respect to a muting target RE selected by the PRS muting resource area determining unit 1120.

The PRS muting resource area determining unit 1120 and the muting unit 1130, which will be described in the following, may operate in cooperation with a resource element mapper which is a component of a base station device (pico cell device), and the PRS muting resource area determining unit 1120 and the muting unit 130 may be embodied to be integrated with the resource element mapper depending on cases.

The entire base station device (pico cell device) will be described in detail with reference to FIG. 12.

FIG. 12 is a functional block diagram illustrating a pico cell device or a non-macro cell device that performs PRS muting according to an embodiment of the present invention.

The pico cell device according to an embodiment of the present invention may include a resource element mapper 1210, the PRS muting device 1100 as shown in FIG. 11, an OFDM signal processor 1230, and the like. A PRS muting device 1200 may include the muting information receiving unit 1110, the PRS muting resource area determining unit 1120, and the muting unit 1130, as described in FIG. 11.

As illustrated in a broken line, the pico cell device 1200 may additionally include configurations for transmitting other data or information, and particularly, may include a scrambler, a modulation mapper, a layer mapper, a precoder, an OFDM signal generator, and the like, which are basic components of a transmit device. However, these configurations are not necessarily required in the present embodiment.

A basic operation of the pico cell device 1200 will be described. Bits input in a form of code words after going through channel coding in a downlink may be scrambled by the scrambler and may be input to the modulation mapper. The modulation mapper modulates the scrambled bits into a complex modulation symbol, and the layer mapper performs mapping of the complex modulation symbol into a single or a plurality of transmission layers. Subsequently, the precoder performs precoding of the complex modulation symbol on each transmission channel of an antenna port. After that, the resource element mapper performs mapping of the complex modulation symbol for each antenna port to a corresponding resource element.

At the same time the basic operation is performed, for PRS muting according to the present embodiment, the muting information receiving unit 1110 receives muting information (or PRS muting information or PDSCH muting information) required for PRS muting from a predetermined macro cell or a component of a higher layer, the PRS muting resource area determining unit 1120 determines a time-frequency resource area in which a predetermined macro cell transmits a PRS based on the received muting information, that is, an RE in which muting is required to be performed, and the muting unit 1130 may not allocate data or may perform zero-power resource allocation with respect to a muting target RE selected by the PRS muting resource area determining unit 1120.

In this example, the muting information required for PRS muting may include a number of subframes of one or more macro cells that transmit PRSs, a PRS transmission period, a transmission offset, period-based PRS transmission activation information (bitmap information), and the like, and may selectively include PRS pattern information of a corresponding cell (that is, the first embodiment excludes the PRS pattern information, and the second embodiment includes the PRS pattern information).

A pico cell may allocate data received from the precoder, to resource elements remaining after a reference signal (RS) excluding a PRS and control signals are allocated to resource elements. In this example, the pico cell performs PRS muting that mutes data with respect to an RE in which a predetermined macro cell transmits a PRS and thus, may generate a time-frequency resource area required for OFDM modulation.

Subsequently, the OFDM signal processor 1230 generates a complex time-domain OFDM signal with respect to the time-frequency resource area for which PRS muting is performed, and transmits the complex time-domain OFDM signal through a corresponding antenna port.

As described above, the PRS muting device 1110 and the resource element mapper 1210 according to an embodiment of the present invention may be embodied to be integrated in a hardware or software manner.

FIG. 13 is a flowchart illustrating a positioning method according to an embodiment of the present invention.

The positioning method according to an embodiment of the present invention is generally performed by a user equipment, but this may not be limited thereto.

A PRS receiving method according to an embodiment of the present invention includes a step S1310 of receiving, from one or more predetermined macro cells, an OFDM signal generated through allocation of a PRS sequence, and receiving, from a pico cell, a PRS muting OFDM signal generated through muting of a resource area to which a PRS sequence of the predetermined macro cell is allocated, a step S1320 of demodulating (Demodulation) the OFDM signal transmitted from the predetermined macro cell, a step S1330 of extracting a PRS sequence of the predetermined macro cell from the demodulated OFDM signal, and a step S1340 of estimating positional information of a user equipment based on the extracted PRS sequence.

In step S1310, the PRS muting OFDM signal that a user equipment receives from a pico cell is a signal that is generated through OFDM modulation after a resource area in which the PRS sequence of the predetermined macro cell is allocated is muted (that is, all PRS patterns in the first embodiment, and in the second embodiment, a process of not allocating data or performing zero-power transmission with respect to a PRS-allocated RE of a predetermined PRS pattern).

Extracting of the PRS sequence in step S1320 may interwork with or may be included in resource element demapping that extracts predetermined information (data or a control signal and the like) from an OFDM signal that is received from a predetermined macro cell and is demodulated. That is, in a process of demodulating an OFDM signal and demapping a resource element, only REs for PRS of a predetermined macro cell are selected from among all REs that are targets of resource element demapping (this corresponds to a PRS pattern), and a PRS sequence mapped to the REs may be extracted.

Estimating positional information in step S1330 extracts a PRS sequence of each macro cell from an OFDM signal transmitted from each macro cell (desirably three or more macro cells), measures a delay time of the OFDM signal transmitted from each macro cell by auto-correlating the extracted PRS sequence and measuring a peak value, and estimates positional information of a user equipment based on triangulation.

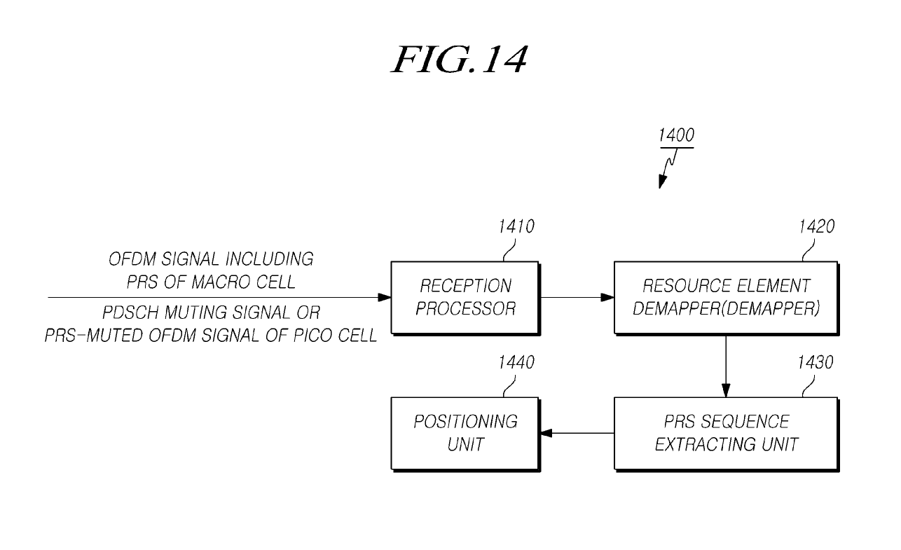

FIG. 14 is a diagram illustrating a configuration of a positioning device or PRS receiving device according to an embodiment of the present invention.

Referring to FIG. 14, a positioning device 1400 includes a reception processor 1410, a resource element de-mapper 1420, a PRS sequence extracting unit 1430, a positioning unit 1440, and the like. Although not illustrated, the positioning device 1400 may additionally include a decoding unit, a controller, and the like. In this example, the positioning device 1400 may correspond to a user equipment 10 of FIG. 1.

The reception processor 1410 performs a function of receiving, from one or more macro cells, an OFDM signal generated through allocation of a PRS sequence, and a function of receiving, from a pico cell, a PRS muting OFDM signal or a PDSCH muting OFDM signal generated through muting of a resource area to which a PRS sequence of a predetermined macro cell is allocated.

The resource element de-mapper 1420 may perform demapping of information allocated to corresponding resource elements, from the OFDM signal received from a macro cell. The demapped information may include various reference signals, such as a PRS associated with a corresponding macro cell and the like, in addition to control information and data information.

The PRS sequence extracting unit 1430 may be a device which is included in or interworks with the resource element de-mapper 1420, and when the resource element de-mapper 1420 performs demapping of the information allocated to corresponding elements, the PRS sequence extracting unit 1430 may perform demapping of information associated with a PRS and may extract a PRS sequence of a macro cell that transmits the corresponding OFDM signal.

Also, the positioning unit 1440 performs a function of estimating positional information of a corresponding user equipment from a PRS sequence associated with one or more (desirably 3 or more) predetermined macro cells, extracted by the PRS sequence extracting unit.

Particularly, the positioning unit 1440 extracts a PRS sequence of each macro cell from an OFDM signal transmitted from each macro cell (desirably 3 or more macro cells), measures a delay time of the OFDM signal transmitted from each macro cell by auto-correlating the extracted PRS sequence and measuring a peak value, and estimates positional information of the user equipment based on triangulation.

Also, the resource element de-mapper 1420 and the PRS sequence extracting unit 1430 of the positioning device 1400 according to the present embodiment may be embodied to be integrated and thus, it may perform a function of extracting a PRS sequence of a macro cell that transmits a corresponding OFDM signal. In the present specifications, the component is referred to as the PRS sequence extracting unit 1430.

The positioning device 1400 according to an embodiment of the present invention may receive, from a pico cell, an OFDM signal that does not include a PRS and that is generated through muting a PRS-allocated area of a macro cell associated with positioning and thus, the corresponding pico cell does not interfere with positioning of a user equipment through a PRS of a macro cell.

According to the embodiments, in a heterogeneous communication environment including a plurality of macro cells and one or more non-macro cells, such as a pico cell and the like, which are different from a macro cell and are included in predetermined macro cells, a non-macro cell performs muting in a resource area in which a PRS of a macro cell that is required for positioning is transmitted and thus, interference between cells may be maximally decreased and a positioning reference signal may be transmitted and received for improving accuracy in measuring a position of a user equipment (UE).

Therefore, there is provided an effect that enables more accurate positioning for a user equipment even in the heterogeneous environment including a non-macro cell.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of muting a positioning reference signal (PRS; Positioning Reference Signal) in a communication system including one or more macro cells and one or more non-macro cells included in the macro cells, the method for the non-macro cell comprising:
determining, based on muting information, a PRS transmission resource area of one or more predetermined macro cells from among the macro cells;
generating a PRS muting resource area by muting a resource area corresponding to the PRS transmission resource area of the one or more predetermined macro cells during resource allocation;
generating a signal by taking into consideration the PRS muting resource area; and
transmitting the generated signal.

2. The method as claimed in claim 1, wherein the muting information includes one or more pieces of information from among a PRS transmission period (T) of a predetermined macro cell, PRS transmission offset (Δ), a number of PRS transmission subframes (N), period-based PRS transmission activation information (bitmap information), and a PRS pattern.

3. The method as claimed in claim 2, wherein the muting information does not include PRS pattern information of the predetermined macro cell, and the non-macro cell mutes PRS-allocated resource elements (RE; Resource Element) of all PRS patterns through which the macro cell is capable of transmitting a PRS.

4. The method as claimed in claim 2, wherein the muting information includes PRS pattern information of the predetermined macro cell, and the non-macro cell mutes only a PRS-allocated RE of a PRS pattern that the predetermined macro cell uses.

5. The method as claimed in claim 1, wherein the one or more predetermined macro cells are selected from among a macro cell of which a corresponding non-macro cell is located in a corresponding cell area, and a macro cell neighboring the macro cell.

6. The method as claimed in claim 1, further comprising:
receiving, by the non-macro cell, the muting information from the predetermined macro cell or a higher layer through signaling.

7. The method as claimed in claim 1, wherein the predetermined macro cell performs:
generating of a unique PRS sequence;
allocating or mapping of, to a time-frequency resource space, the generated PRS sequence using PRS transmission information;
generating of a signal including the allocated or mapped PRS sequence; and
transmitting of the generated signal.

8. The method as claimed in claim 7, further comprising:
generating, by the predetermined macro cell, the muting information corresponding to information associated with a resource space where the PRS sequence is allocated, and transmitting the muting information to the non-macro cell.

9. A device for muting a positioning reference signal (PRS; Positioning Reference Signal) of a non-macro cell in a communication system including one or more macro cells and one or more non-macro cells included in the macro cells, the device comprising:
a muting information receiving unit to receive muting information from one or more predetermined macro cells from among the macro cells or from a higher layer;
a PRS muting resource area determining unit to determine, based on the muting information, a time-frequency resource area where a predetermined macro cell transmits a PRS as a muting target resource element (RE; Resource Element); and
a muting unit to allocate a resource so as not to allocate data or to perform zero-power transmission with respect to the muting target RE.

10. The device as claimed in claim 9, wherein the muting information includes a PRS transmission period (T) of the predetermined macro cell, a PRS transmission offset (Δ), a number of PRS transmission subframes (N), and period-based PRS transmission activation information (bitmap information); and
the PRS muting resource area determining unit determines PRS-allocated REs of all PRS patterns through which the macro cell is capable of transmitting a PRS, as the muting target REs.

11. The device as claimed in claim 9, wherein the muting information includes a PRS transmission period (T) of the predetermined macro cell, PRS transmission offset (Δ), a number of PRS transmission subframes (N), period-based PRS transmission activation information (bitmap information), and a PRS pattern; and
the PRS muting resource area determining unit determines only a PRS-allocated RE of a PRS pattern that the predetermined macro cell uses, as the muting target RE.

12. A positioning method for a positioning device that receives a positioning reference signal (PRS; Positioning Reference Signal) and measures a position in a communication system including one or more macro cells and one or more non-macro cells included in the macro cells, the method for the positioning device comprising:
receiving a signal generated through allocation of a PRS sequence, from one or more predetermined macro cells from among the macro cells, and receiving, from the non-macro cell, an entire pattern of a resource area to which a PRS sequence of the predetermined macro cell is allocated or a signal generated through selective muting of the resource area;
demodulating the received signal;
extracting a PRS sequence of the predetermined macro cell from the demodulated signal; and
estimating positional information using the extracted PRS sequence.

13. A positioning device for receiving a positioning reference signal (PRS; Positioning Reference Signal) and measuring a position in a communication system including one or more macro cells and one or more non-macro cells included in the macro cells, the device comprising:
a reception processor to receive a signal generated through allocation of a PRS sequence, from one or more predetermined cells from among the macro cells, and to receive, from the non-macro cell, an entire pattern of a resource area to which a PRS sequence of the predetermined macro cell is allocated or a signal generated through selective muting of the resource area;
a PRS sequence extracting unit to perform demapping of information allocated to each resource element of the received signal, and to extract a PRS sequence of the predetermined macro cell that transmits the corresponding signal; and
a positioning unit to estimate positional information using the one or more extracted PRS sequences.

14. A positioning reference signal muting method in a heterogeneous communication system including one or more macro cells and one or more non-macro cells included in each macro cell, wherein the non-macro cell does not separately transmit a positioning reference signal (PRS; Positioning Reference Signal), and does not transmit data and performs muting in a time-frequency resource area where one or more predetermined macro cells from among the macro cells transmit a positioning reference signal.
